(19) United States
(12) Patent Application Publication
(10) Pub. No.: US 2020/0104575 A1
(43) Pub. Date: Apr. 2, 2020

(54) LIVING BODY RECOGNITION METHOD AND ELECTRONIC DEVICE

(71) Applicant: Acer Incorporated, New Taipei City (TW)

(72) Inventors: Tsung-Han Yang, New Taipei City (TW); Kuan-Chung Hou, New Taipei City (TW); Chian-Ying Li, New Taipei City (TW); Chang-Hung Wang, New Taipei City (TW); Bo-Ting Wu, New Taipei City (TW); Andy Ho, New Taipei City (TW); Szu-Chieh Wang, New Taipei City (TW); Tsung-Yao Chen, New Taipei City (TW)

(73) Assignee: Acer Incorporated, New Taipei City (TW)

(21) Appl. No.: 16/404,762

(22) Filed: May 7, 2019

(30) Foreign Application Priority Data
Sep. 27, 2018 (TW) 107134179

(51) Int. Cl. G06K 9/00

(52) U.S. Cl. CPC G06K 9/00288; G06K 9/00335; G06K 9/00228; G06K 9/00302

(57) ABSTRACT

A living body recognition method and an electronic device are provided. The method includes: providing a prompt information, wherein the prompt information is used to instruct a user to make a first action; capturing at least one image corresponding to the user according to the prompt information; determining whether a second action made by the user in the at least one image meets a specific condition according to the prompt information and the image; determining that the user in the at least one image is a living body when the second action made by the user in the at least one image meets the specific condition; and determining that the user in the at least one image is not the living body when the second action made by the user in the at least one image does not meet the specific condition.

### CROSS-REFERENCE TO RELATED APPLICATION

This application claims the priority benefit of Taiwan application serial no. 107134179, filed on Sep. 27, 2018. The entirety of the above-mentioned patent application is hereby incorporated by reference herein and made a part of this specification.

### BACKGROUND OF THE INVENTION

### Field of the Invention

The invention relates to a living body recognition method and an electronic device.

### Description of Related Art

People who are engaged in outdoor activities for long periods of time, such as mountain rafting, field surveys, mountain patrols, etc., often need to keep in touch with the garrison personnel on the ground to ensure their safety. However, in this outdoor situation, the electronic device used by the report personnel must have three conditions: (1) easy to carry, (2) power saving, and (3) high reliability. Therefore, the electronic device used by the report personnel cannot be installed with too many sensors. In addition, in order to determine whether the identity of the report personnel is forged, identity verification is also one of the issues to be considered.

In addition, the use of passwords or gestures to protect folders is the most common and easiest way to use electronic photo frames. However, such passwords or gestures that rely on memory may cause a lot of trouble to the user if they are forgotten.

### SUMMARY OF THE INVENTION

The invention provides a living body recognition method and an electronic device that may effectively recognize whether a user in a captured image is a living body (or a biological organism) and increase the credibility of identity verification.

The invention provides a living body recognition method for an electronic device. The method includes the following steps. A prompt information is provided, wherein the prompt information is used to instruct a user to make a first action. At least one image corresponding to the user is captured according to the prompt information. Whether a second action made by the user in the at least one image meets a specific condition is determined according to the prompt information and the image. The user in the at least one image is determined to be a living body when the second action made by the user in the at least one image meets the specific condition. The user in the at least one image is determined to not be the living body when the second action made by the user in the at least one image does not meet the specific condition.

In an embodiment of the invention, the specific condition is a corresponding relationship between the first action and the second action.

In an embodiment of the invention, in the corresponding relationship, the first action is different from the second action.

In an embodiment of the invention, in the corresponding relationship, the first action is the same as the second action.

In an embodiment of the invention, the first action and/or the second action includes at least one of an expression, a gesture, a facial direction, a facial movement trajectory, and a facial habit of the user.

The invention provides an electronic device, and the electronic device includes: an output circuit, an image-capture circuit, and a processor. The processor is coupled to the output circuit and the image-capture circuit. The output circuit provides a prompt information, wherein the prompt information is used to instruct a user to make a first action. The image-capture circuit captures at least one image corresponding to the user according to the prompt information. The processor determines whether a second action made by the user in the image meets a specific condition according to the prompt information and the image. The processor determines that the user in the image is a living body when the second action made by the user in the image meets the specific condition. The processor determines that the user in the image is not the living body when the second action made by the user in the image does not meet the specific condition.

In an embodiment of the invention, the specific condition is a corresponding relationship between the first action and the second action.

In an embodiment of the invention, in the corresponding relationship, the first action is different from the second action.

In an embodiment of the invention, in the corresponding relationship, the first action is the same as the second action.

In an embodiment of the invention, the first action and/or the second action includes at least one of an expression, a gesture, a facial direction, a facial movement trajectory, and a facial habit of the user.

Based on the above, the living body recognition method and the electronic device of the invention may recognize whether the user in the captured image is a living body (or a biological organism), thereby increasing the difficulty of identity fraud and improving the security of the data. In particular, since the invention uses image recognition, only a single camera lens is needed in terms of manufacturing cost, and the overall cost of the electronic device is not significantly increased.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device shown according to an embodiment of the invention.

FIG. 2 is a flowchart of a living body recognition method shown according to an embodiment of the invention.

### DESCRIPTION OF THE EMBODIMENTS

Descriptions of the invention are given with reference to the exemplary embodiments illustrated with accompanied drawings. In addition, whenever possible, elements/components having the same reference numerals represent the same or similar parts in the figures and the embodiments.

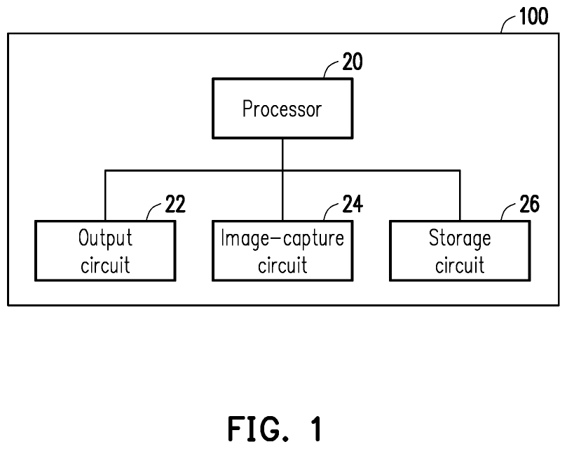

FIG. 1 is a block diagram of an electronic device shown according to an embodiment of the invention.

Referring to FIG. 1, an electronic device 100 includes a processor 20, an output circuit 22, an image-capture circuit 24, and a storage circuit 26. In particular, the output circuit 22, the image-capture circuit 24, and the storage circuit 26 are respectively coupled to the processor 20. The electronic device 100 is, for example, a device such as a mobile phone, a tablet computer, a notebook computer, or an electronic photo frame, and is not limited herein.

The processor 20 may be a central processing unit (CPU) or a programmable general-use or specific-use microprocessor, digital signal processor (DSP), programmable controller, application-specific integrated circuit (ASIC), or other similar devices or a combination thereof.

The output circuit 22 may be a display device that provides a display function within the display area of electronic device 100. The output circuit 22 may be a display device that provides a display function such as a liquid crystal display (LCD), a light-emitting diode (LED), a field emission display (FED), or the like. However, in another embodiment, the output circuit 22 may also be other types of output devices, such as a speaker, and the output circuit 22 is not limited herein.

The image-capture circuit 24 is for capturing one or a plurality of images. For example, the image-capture circuit 24 may be equipped with a camera lens of a charge-coupled device (CCD), a complementary metal-oxide semiconductor (CMOS) device, or other types of photosensitive devices.

The storage circuit 26 may be any type of fixed or movable random-access memory (RAM), read-only memory (ROM), flash memory, a similar device, or a combination of the devices.

In the present exemplary embodiment, a plurality of code snippets is stored in the storage circuit 26 of the electronic device 100, and after the code snippets are installed, the code snippets are executed by the processor 20. For example, the storage circuit 26 includes a plurality of modules, and the modules are respectively used to execute various operations applied to the electronic device 100, wherein each module is composed of one or a plurality of code snippets. However, the invention is not limited thereto, and the various operations of the electronic device 100 may also be implemented in other hardware forms.

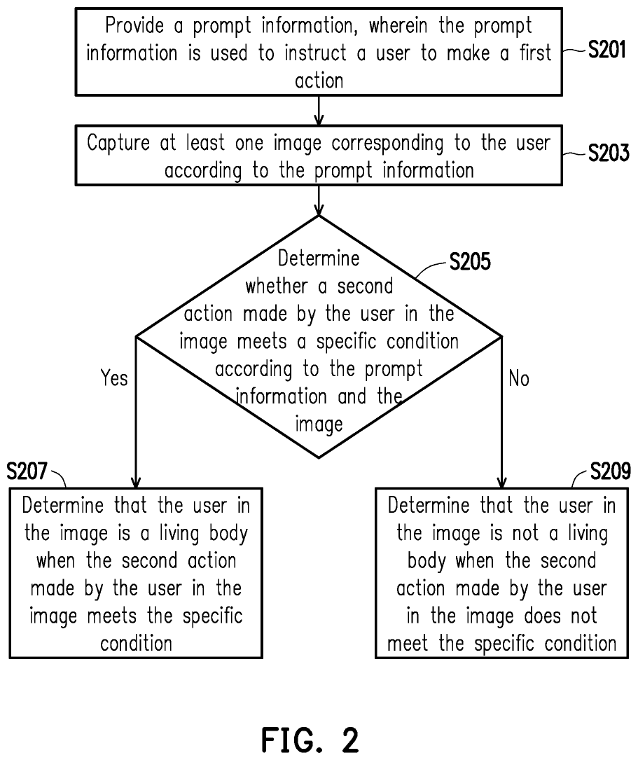

FIG. 2 is a flowchart of a living body recognition method shown according to an embodiment of the invention.

Referring to FIG. 2, the output circuit 22 provides a prompt information (step S201). In particular, the prompt information is used to instruct a user to make a first action. Here, the first action includes at least one of an expression, a gesture, a facial direction, a facial movement trajectory, and a facial habit of the user. More specifically, the expression may include happy, sad, angry, disgusted, sad, surprised, or other expressions. The gesture is, for example, a thumbs up, fist, open palm, or other gestures. The facial direction is, for example, the output circuit 22 displaying a plurality of fixed positions according to the prompt information, and the user sequentially turns the face toward the fixed positions according to the prompt information and respectively keeps the face at the fixed positions for a certain length of time. The facial movement trajectory is, for example, the output circuit 22 displaying a specific trajectory according to the prompt information, and the user moves the face according to the specific trajectory so that the movement trajectory of the user's face is conformed to the specific trajectory displayed by the output circuit 22. The facial habit of the user is, for example, a specific angle, expression, or other habits of the user facing the lens.

After the output information is provided by the output circuit 22, the image-capture circuit 24 captures at least one image corresponding to the user according to the prompt information (step S203). For example, the user may make a corresponding action in front of the electronic device 100 according to the prompt information so that the image-capture circuit 24 of the electronic device 100 captures an image including the user.

Then, the processor 20 determines whether the action (also referred to as the second action) made by the user in the image captured by the image-capture circuit 24 meets a specific condition according to the prompt information and the image captured by the image-capture circuit 24 (step S205). The second action includes at least one of an expression, a gesture, a facial direction, a facial movement trajectory, and a facial behavior of the user, which is similar to the first action, and is not repeated herein. The specific condition is the corresponding relationship between the first action and the second action. In an embodiment, the corresponding relationship may be that the first action is the same as the second action. As an example, the prompt information is used to instruct the user to make the first action which is a fist. When the second action made by the user in the image captured by the image-capture circuit 24 is a fist, the processor 20 determines the second action made by the user in the image captured by the image-capture circuit 24 meets a specific condition. As another example, the prompt information is used to instruct the user to make the first action which is a fist. When the second action made by the user in the image captured by the image-capture circuit 24 is not a fist, the processor 20 determines the second action made by the user in the image captured by the image-capture circuit 24 does not meet the specific condition.

However, in another embodiment, in the corresponding relationship, the first action may also be different from the second action. For example, the processor 20 may pre-store the corresponding relationship between the first action and the second action in the storage circuit 26, and the first action is different from the second action. For example, the processor 20 may pre-store the corresponding relationship in which the first action is a fist and the second action is an angry expression in the storage circuit 26. When the prompt information instructs the user to make the first action of the fist and the second action made by the user in the image captured by the image-capture circuit 24 is an angry expression, the processor 20 determines that the second action made by the user in the image captured by the image-capture circuit 24 meets the specific condition. On the other hand, when the prompt information instructs the user to make the first action of the fist and the second action made by the user in the image captured by the image-capture circuit 24 is a fist, the processor 20 determines that the second action made by the user in the image captured by the image-capture circuit 24 does not meet the specific condition. In particular, by using the first action and the second action that are different from each other for verification, the accuracy of identity recognition and the protection of confidential data may be improved.

When the second action made by the user in the image captured by the image-capture circuit 24 meets the specific condition, the processor 20 determines that the user in the image captured by the image-capture circuit 24 is a living body (or a biological organism) (step S207). When the second action made by the user in the image captured by the image-capture circuit 24 does not meet the specific condition, the processor 20 determines that the user in the image captured by the image-capture circuit 24 is not a living body (or a biological organism) (step S209).

The application of the living body recognition method of the invention is described below in two embodiments.

### First Embodiment

In outdoor mountaineering activities, there are usually personnel (hereinafter referred to as garrison personnel) who stay on the ground, and those who participate in mountaineering activities usually need personnel (hereinafter referred to as report personnel) to report relevant information to the garrison personnel. As an example, the electronic device 100 is held by a report personnel, and in order to verify the identity of the report personnel, the garrison personnel may use other electronic devices to transmit a prompt information to the electronic device 100 of the report personnel for display. The report personnel may make a corresponding second action according to the first action specified in the prompt information. If the second action made by the report personnel meets a specific condition, then the electronic device 100 determines that the report personnel is a living body (or a biological organism). If the second action made by the report personnel does not meet the specific condition, then the electronic device 100 determines that the report personnel is not a living body (e.g., a photo, video, etc.)

By verifying whether the user in the image is a living body, in addition to preventing someone from reporting in the place of the report personnel using a forged picture or video, the difficulty of identity fraud may be further increased and the authenticity that the report personnel must be a living body may be improved, assuming that the first action in the prompt information is randomly specified.

### Second Embodiment

As an example, the electronic device 100 is an electronic photo frame. The electronic device 100 may first determine whether the user is the owner of a folder by a technique of facial recognition. Next, the electronic device may generate and display a prompt information. The user may make a corresponding second action according to the first action specified in the prompt information. If the second action made by the user meets a specific condition, then the electronic device 100 determines that the user is a living body (or a biological organism). If the second action made by the user does not meet the specific condition, then the electronic device 100 determines that the report personnel is not a living body (e.g., a photo, video, etc.)

By adding a mechanism for biometric verification on the electronic photo frame, in addition to preventing someone from using fake images or videos to open other people's folders, the difficulty of identity fraud may be further increased and the security of the folder may be improved, assuming the first action in the prompt information is randomly specified.

Based on the above, the living body recognition method and the electronic device of the invention may recognize whether the user in the captured image is a living body (or a biological organism), thereby increasing the difficulty of identity fraud and improving the security of the data. In particular, since the invention uses image recognition, only a single camera lens is needed in terms of manufacturing cost, and the overall cost of the electronic device is not significantly increased.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A living body recognition method for an electronic device, the method comprising:
providing a prompt information, wherein the prompt information is used to instruct a user to make a first action;
capturing at least one image corresponding to the user according to the prompt information;
determining whether a second action made by the user in the image meets a specific condition according to the prompt information and the image;
determining that the user in the image is a living body when the second action made by the user in the image meets the specific condition; and
determining that the user in the image is not the living body when the second action made by the user in the image does not meet the specific condition.

2. The living body recognition method of claim 1, wherein the specific condition is a corresponding relationship between the first action and the second action.

3. The living body recognition method of claim 2, wherein in the corresponding relationship, the first action is different from the second action.

4. The living body recognition method of claim 2, wherein in the corresponding relationship, the first action is the same as the second action.

5. The living body recognition method of claim 1, wherein the first action and/or the second action comprises at least one of an expression, a gesture, a facial direction, a facial movement trajectory, and a facial habit of the user.

6. An electronic device, the electronic device comprising:
an output circuit;
an image-capture circuit; and
a processor coupled to the output circuit and the image-capture circuit, wherein
the output circuit provides a prompt information, wherein the prompt information is used to instruct a user to make a first action,
the image-capture circuit captures at least one image corresponding to the user according to the prompt information,
the processor determines whether a second action made by the user in the image meets a specific condition according to the prompt information and the image,
the processor determines that the user in the image is a living body when the second action made by the user in the image meets the specific condition, and
the processor determines that the user in the image is not the living body when the second action made by the user in the image does not meet the specific condition.

7. The electronic device of claim 6, wherein the specific condition is a corresponding relationship between the first action and the second action.

8. The electronic device of claim 7, wherein in the corresponding relationship, the first action is different from the second action.

9. The electronic device of claim 7, wherein in the corresponding relationship, the first action is the same as the second action.

10. The electronic device of claim 6, wherein the first action and/or the second action comprises at least one of an expression, a gesture, a facial direction, a facial movement trajectory, and a facial habit of the user.
